(19) United States
(12) Patent Application Publication
(10) Pub. No.: US 2006/0130896 A1
(43) Pub. Date: Jun. 22, 2006

(54) High reliability gas mixture back-up system

(76) Inventor: Gregory Joseph Skibinski, Orefield, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 10/753,134

(22) Filed: Jan. 7, 2004

(51) Int. Cl. E03B 1/00; F17C 11/00

(52) U.S. Cl. 137/7; 62/46.1

(57) ABSTRACT

A high reliability gas mixture backup system and method using same are disclosed herein comprising a high pressure gas mixture storage system and a cryogenic liquid blending gas mixture generation system. In one embodiment the high pressure gas mixture storage system provides instantaneous delivery of a precise gas mixture for a short duration of time, and the cryogenic liquid blending gas mixture generation system provides delivery of a precise gas mixture for an extended duration of time, wherein the backup system provides a large volume of a precise mixture of the gas mixture substantially instantly and then for extended periods of time, with high reliability.

### BACKGROUND OF THE INVENTION

Manufacturers require gas mixture back-up supply systems that can instantaneously supply precise gas mixture compositions, instantaneously supply large gas mixture volumes, supply gas mixtures for extended periods of time, and provide high reliability. As used herein, the term “precise gas mixture” may describe a mixture of two or more gases that are delivered as a mixture containing certain definitive amounts of each gas, such as, for example, compressed dry air that is comprised of 79.05% nitrogen and 20.95% oxygen. In this connection, manufacturers of semiconductors may require compressed dry air instantaneously at precise compositions. These manufacturers need to maintain precise refractive characteristics for optical processes and provide instantaneous large volumes of a particular gas mixture in order to support high production facilities for extended periods of time. Such systems should also allow for modifications and maintenance to the primary compressed dry air supply system with high reliability to avoid the interruption of the manufacturing of semiconductors.

Existing technologies are impractical for instantaneously providing gas mixtures at precise compositions, instantaneously providing gas mixtures in large volumes, providing gas mixtures for extended periods of time, and providing high reliability. Teachings in the prior art have also been deficient. One teaching in the prior art is to install one or multiple redundant gas mixture generation systems. This system is economically impractical because of the high installation and operating cost of one or multiple gas mixture generation systems. Further, redundant gas mixture generation systems fail to provide the necessary high reliability because they cease to produce gas mixtures without electrical power and are too large to be economically equipped with uninterruptable electrical power systems.

Another example of a system in the prior art is to use compressed gas mixture storage. Gas mixtures can often be stored in gaseous form in pressure vessels. Typically, this type of gas mixture back-up supply system stores gas mixtures at pressures higher than the required delivery pressure. This system is effective for maintaining an instantaneous and precise gas mixture composition. Further, this system is often immune to the interruption of electrical power. However, this system is deficient in that it is economically impractical for the supply of large gas mixture volumes for extended periods of time.

A further teaching in the prior art is a cryogenic liquid blending gas mixture generation system. Gas mixtures can be created from blending one or multiple cryogenic liquids. These methods are described, for example, in U.S. Pat. Nos. 5,778,678 and 5,865,206. Cryogenic liquid blending gas mixture generation systems described by these patents are capable of supplying gas mixtures at precise compositions, in large volumes, for extended periods of time, and with high reliability. However, the systems described in these patents are deficient in that they cannot instantaneously provide a precise gas mixture when initially operated. It is impractical for these systems to initially deliver a precise gas mixture when starting operation from an idle mode at ambient temperature. Although suitable for some applications with relatively greater gas mixture tolerances, for example, in combustion applications, they do not provide instantaneous and precise gas mixtures for stringent applications like those involved in the manufacture of semiconductors. Additionally, the systems described in the U.S. Pat. Nos. 5,778,678 and 5,865,206 patents also rely on buffer tanks that can not be pressurized beyond the limits of the cryogenic storage vessels. Although suitable for low gas mixture volume requirements, high pressure cryogenic storage vessels are not economically feasible for the storage of large volumes of cryogenic liquid required to support high gas mixture volume requirements. This practical limitation requires the buffer tank to be excessively large, and likewise expensive, to be capable of handling the pressure fluctuations associated with typical instantaneous gas mixture volumes such as, for example, 300,000 to 700,000 scfh required by some semiconductor manufacturers.

U.S. Pat. No. 3,397,548 teaches a method for supplying a gaseous product to meet variable demand. Here, product gas from a separation plant is withdrawn exclusively in gaseous form and, when product gas is produced faster than required, the excess is withdrawn in gaseous form and is passed through a condenser in a storage vessel and liquified by heat exchange with previously liquified raw or residual gas. During times when product gas is to be delivered for use as fast as it is produced, the product gas is employed as a refrigerant in a heat exchanger to cool raw air being supplied to the rectifying column.

Accordingly, there is a need in the art for a high reliability gas mixture backup supply system. There is a further need in the art for a gas mixture backup supply system that is capable of instantaneously providing a large volume of a precise mixture of a gas for extended periods of time, with high reliability. There is a still further need for a high reliability gas mixture backup supply system of decreased complexity and improved reliability over prior systems. There is yet a further need for a high reliability gas mixture backup supply system where a high pressure gas mixture storage system provides for instantaneous delivery of a gas mixture from high pressure storage vessels and a cryogenic liquid blending gas mixture generation system provides an extended supply time of a precise gas mixture. There is yet another need for a high reliability gas mixture backup supply system that is highly reliable despite long periods of idle time of the system.

### BRIEF SUMMARY OF THE INVENTION

The present invention satisfies one, if not all, of the needs of the art by providing a high reliability gas mixture backup system and a method using same. In one embodiment, the high reliability gas mixture backup system has a high pressure gas mixture storage system and a cryogenic liquid blending gas mixture generation system. The high pressure gas mixture storage system provides instantaneous delivery of a precise gas mixture for a short duration and not for a long duration, and the cryogenic liquid blending gas mixture generation system provides delivery of a precise gas mixture for an extended duration and not for a short duration. The backup system provides a large volume of a precise mixture of the gas mixture substantially instantly and then for extended periods of time, with high reliability.

In one embodiment, the high pressure gas mixture storage system provides for instantaneous delivery of a gas mixture from high pressure storage vessels. The high pressure gas mixture storage system is preferably kept pressurized to 2:1 to 40:1 of the required delivery pressure. The high pressure gas mixture storage system may be pressurized by high pressure vaporization vessels utilizing compressed gas directly from the primary gas mixture generation system. The high pressure gas mixture storage system may be pressurized by cryogenic pumps utilizing compressed gas directly from the primary gas mixture generation system. The high pressure gas mixture storage system may use a cryogenic liquid charging system designed to produce a precise gas mixture composition at a required high pressure storage vessel pressure. Alternatively, the high pressure gas mixture storage system may use a high pressure product compressor. Preferably, the high pressure gas mixture storage system is adapted to act as a gas mixture back-up for up to 20 minutes.

Additionally, the cryogenic liquid blending gas mixture generation system preferably uses cryogenic liquids that can be stored at low pressures, above a required delivery pressure. The cryogenic liquid blending gas mixture generation system preferably uses components that require energy which are all either pneumatically operated by pressure generated by a common cryogenic liquid vaporization pneumatic back-up system and/or, where electrical or electronic components are utilized, electrical or electronic components that have low power requirements supplied by an uninterruptable power supply to ensure high reliability. The cryogenic liquid blending gas mixture generation system preferably has monitors that monitor the high pressure gas mixture system to determine if the high pressure gas mixture system is providing a gas mixture. These monitors may include pressure sensors, flow sensors, and valve position sensors. The system may include a sensor adapted to signal that the high pressure gas mixture system is supplying a gas mixture, to signal the cryogenic liquid blending gas mixture generation system to begin preparing a precise gas mixture.

A process for providing a precise gas mixture from a high reliability gas mixture backup system is also provided. The process includes the steps of providing a high pressure gas mixture storage system, providing a cryogenic liquid blending gas mixture generation system, instantaneously delivering a precise gas mixture from the high pressure storage system for a short duration and not for an extended duration, and delivering the precise gas mixture from the cryogenic liquid blending gas mixture generation system for an extended duration and not for a short duration. The backup system instantaneously provides a large volume of a precise mixture of the gas mixture substantially instantly and then for extended periods of time, with high reliability.

The process may further provide using high pressure storage vessels and pressurizing the high pressure gas mixture storage system to 2:1 to 40:1 of a required delivery pressure. Additionally, the process may include pressurizing pressure vaporization vessels utilizing compressed gas directly from a primary gas mixture generation system. The system may include pressurizing by cryogenic pumps utilizing compressed gas directly from a primary gas mixture generation system. The system may include providing a cryogenic liquid charging system designed to produce a precise gas mixture composition at a required high pressure storage vessel pressure. Alternatively, the process may include providing a high pressure product compressor designed to produce a precise gas mixture composition at a required high pressure storage vessel pressure. Preferably, the high pressure storage system provides a gas mixture back-up for up to 20 minutes.

Additionally, the process preferably uses cryogenic liquids that can be stored at low pressures, above a required delivery pressure. The process preferably uses components that require energy which are all pneumatically operated either by pressure generated by a common cryogenic liquid vaporization pneumatic back-up system and/or, where electrical or electronic components are utilized, electrical or electronic components that have low power requirements supplied by an uninterruptable power supply to ensure high reliability. The process further preferably utilizes monitors that monitor the high pressure gas mixture system to determine if the high pressure gas mixture system is providing a gas mixture. Those monitors may include pressure sensors, flow sensors, and valve position sensors. The process may further include a sensor adapted to signal that the high pressure gas mixture system is supplying a gas mixture and/or to signal the cryogenic liquid blending gas mixture generation system to begin preparing a precise gas mixture.

### BRIEF DESCRIPTION OF THE DRAWINGS

FIG. 1 is a schematic diagram of a high reliability gas mixture backup system in accordance with one preferred embodiment of the present invention.

FIG. 2 is a schematic diagram of a high pressure gas mixture system of the high reliability gas mixture backup system of FIG. 1.

FIG. 3 is a schematic diagram of an alternate high pressure gas mixture system of the high reliability gas mixture backup system of FIG. 1.

FIG. 4 is a schematic diagram of a cryogenic liquid blending gas mixture generation system of a high reliability gas mixture backup system of FIG. 1.

### DETAILED DESCRIPTION OF THE INVENTION

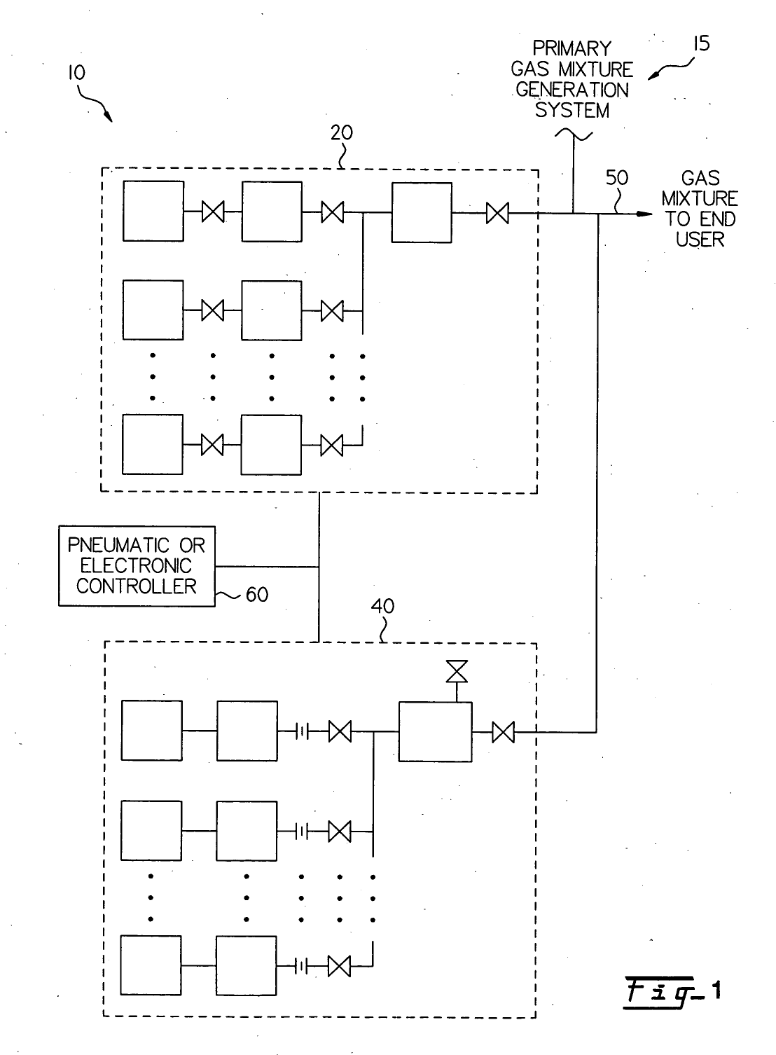

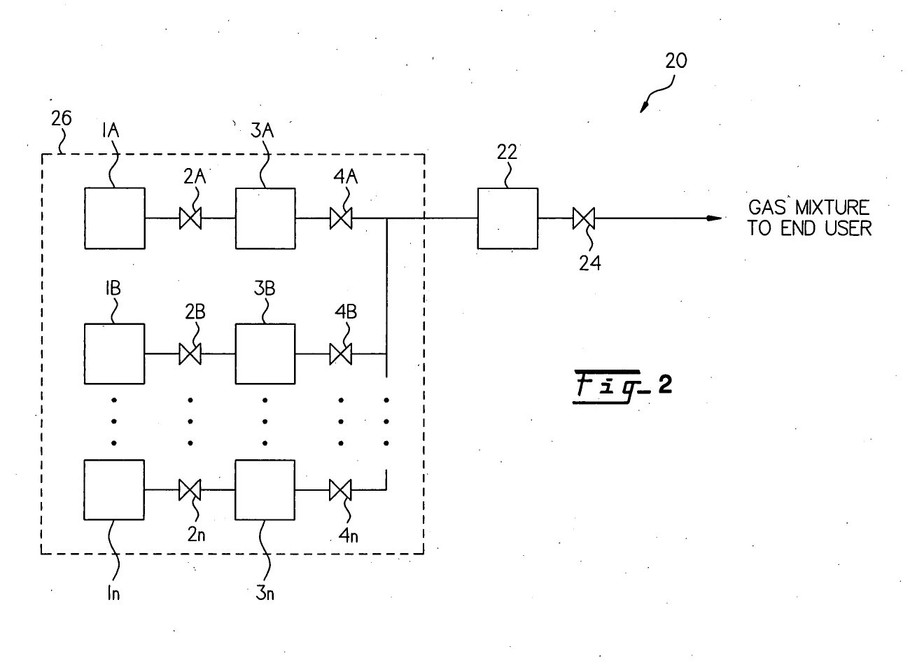

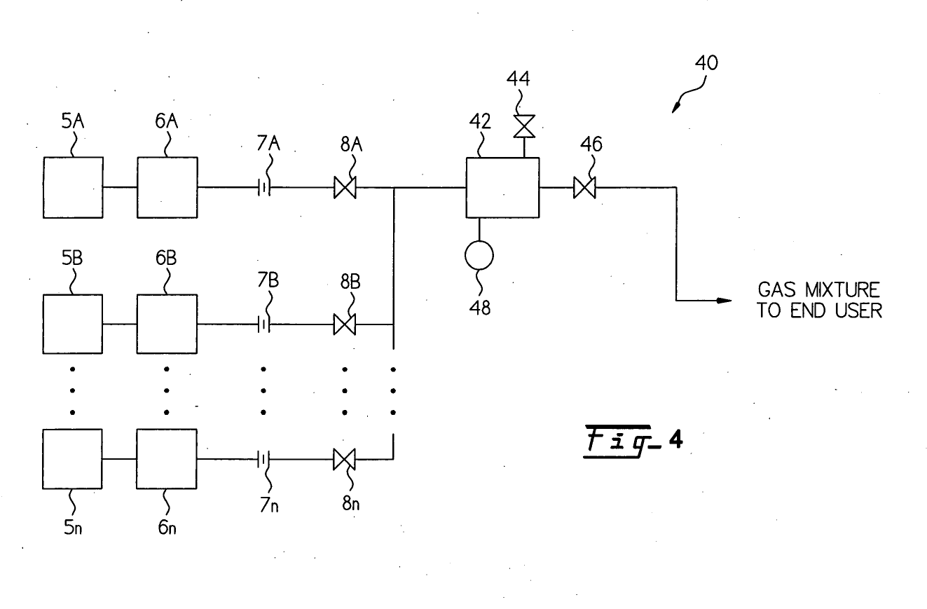

Referring now to the drawings, there is shown in FIG. 1, a high reliability gas mixture backup system 10 in accordance with one embodiment of the present invention. The high reliability gas mixture backup system 10 comprises two major components, a high pressure gas mixture system 20 (see FIG. 2) and a cryogenic liquid blending gas mixture generation system 40 (see FIG. 4).

The high pressure gas mixture system 20 is shown in FIG. 2 in the preferred embodiment with cryogenic liquid charging. High pressure storage vessel (or vessels) 22 stores the required gas mixture at a precise composition and at a pressure greater than the delivery pressure at the gas delivery point 50 (FIG. 1) required by a customer or the required delivery pressure. Examples of typical required delivery pressures may range from 130 to 155 psig. Examples of typical high pressure storage vessel pressures may range from 285 to 3600 psig, or from 285 to 360 psig. Although substantially any pressure is possible, certain applications may require the high pressure storage vessel 22 to operate at ratios typically in the range of 2:1 to 40:1 of delivery pressure at the gas delivery point 50. Equipment is typically available in the 3000 psig range for high pressure industrial gas cylinders, so this is an economically practical range for the high pressure gas mixture system 20. The high pressure storage vessel or vessels 22 may be equipped with various typical operating components to ensure safe operation and monitor the gas composition (not shown).

The pressure control system 24 is typical of those used in the industrial gas industry. It may consist of one or more pressure regulators or pressure control valves with other necessary components like block valves, pressure safety valves, buffer tanks, and the like. After charging, the pressure control system 24 is capable of instantaneously supplying the precise gas mixture composition at the required pressure when the pressure at gas delivery point 50 falls below a predetermined value. This high pressure gas mixture system system 20 would be designed to act as a gas mixture back-up for a short duration, typically from 0.1 to 20 minutes. The sole purpose of the high pressure gas mixture system 20 would be to provide enough time for the cryogenic liquid blending gas mixture generation system 40, as discussed below, to produce and begin supplying the precise gas mixture. The limited amount of time that the high pressure gas mixture system 20 would be required to operate allows the high pressure storage vessel or vessels 22 to be reduced in size and cost.

Typically, the pressure control system 24 components that require energy will be pneumatically operated by pressure generated by a common cryogenic liquid vaporization pneumatic back-up system, as known in the art. Typically, electrical or electronic components, if desired, would have low power requirements and would be supplied by an uninterruptable power supply to ensure high reliability, also as known in the art.

The cryogenic liquid charging system 26 is designed to produce the precise gas mixture composition at the required high pressure storage vessel 22 pressure. For example, if a mixture of Gas A, Gas B, etc. through Gas n was desired, the correct gas mixture would be generated in a batch process by opening cryogenic liquid A inlet valves 2A which are connected to cryogenic liquid storage 1A, consisting of one or more manual or automatic valves and other components, and filling the high pressure vaporization vessel 3A to a predetermined liquid level designed to provide the correct mass of cryogenic liquid A. After filling the high pressure vaporization vessel 3A, the cryogenic liquid A inlet valve(s) 2A would be closed and the cryogenic liquid A discharge valve(s) 4A would be opened. The ambient temperature or another heating method would vaporize the liquid in the high pressure vaporization vessel 3A. This procedure would be duplicated for all necessary cryogenic liquids B through n to produce the precise gas mixture composition. If high pressure vaporization vessels were not desired, high pressure cryogenic pumps and vaporizers could be substituted to provide high pressure gases.

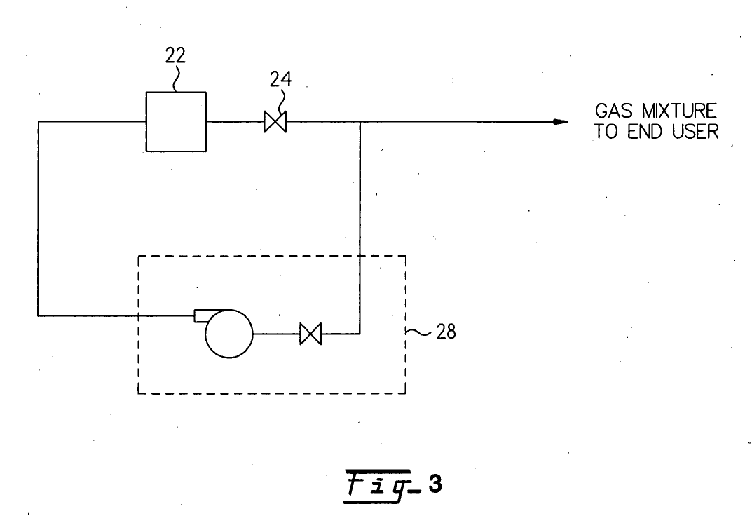

Alternatively, the high pressure storage vessel 22 could be charged using a high pressure product compressor 28 as shown in FIG. 3. This compressor 28 would take the precise gas mixture from a primary gas mixture generation system 15 and compress it to fill the high pressure storage vessel 22. This would be a batch process and could be manual or automatic.

The cryogenic liquid blending gas mixture generation system 40 is depicted in FIG. 4 and is similar in operation to those described in U.S. Pat. Nos. 5,778,678 and 5,865,206, the specifications of which are incorporated by reference. The major improvement of the present invention is that the high pressure gas mixture system 20 (see FIGS. 1 and 2) provides a short duration lag time such that the cryogenic liquid blending gas mixture generation system 40 would not be required to instantaneously provide a precise gas mixture at a specific pressure from an idle mode.

The relatively short duration lag time allows the cryogenic liquid blending gas mixture generation system 40 sufficient time to reach stable operation and maintain a precise gas mixture. As a result of this short duration lag time, the cryogenic liquid blending gas mixture generation system 40 may consist of fewer components than other systems and provide higher reliability.

Typically, the cryogenic liquid blending gas mixture generation system 40 components that require energy will be pneumatically operated by pressure generated by a common cryogenic liquid vaporization pneumatic back-up system. Typically, electrical or electronic components, if desired, would have low power requirements and would be supplied by an uninterruptable power supply to ensure high reliability (not shown).

The cryogenic liquid blending gas mixture generation 40 system would constantly monitor the high pressure gas mixture system 20 using pneumatic or electronic controller 60 to determine if it is providing a gas mixture to the customer. Monitoring could be accomplished using a variety of common methods including, but no limited to, pressure sensors, flow sensors, valve position sensors, and the like. These sensors could be pneumatic, electrical, or electronic.

Upon sensing that the high pressure gas mixture system 20 is supplying a gas mixture to the customer, the cryogenic liquid blending gas mixture generation system 40, shown in FIG. 4, would begin the process of preparing a precise gas mixture. During the initial start-up, the controller 60 (see FIG. 1) would automatically attempt to control the flow of gases by monitoring the gas flow meters 7A, 7B, etc. through 7n which are connected to cryogenic liquid storage 5A, 5B, etc. through 5n and cryogenic liquid vaporization system 6A, 6B, etc. through 6n. The controller would operate the gas flow control valves 8A, 8B, etc. through 8n to maintain the correct gas mixture in mixing tank 42. The composition of the gas mixture during this initial period would likely not be acceptable and the gas mixture that is not within specification would be vented through the mixing vent 44. Venting would continue for a predetermined amount of time to allow the controller 60 to establish the correct gas composition. Alternatively, one or more gas analyzers 48 could monitor the gas mixture composition in the mixing tank 42 and provide feedback to the controller 60 to adjust specific gas flows. Initially, this gas mixture would be disposed of through the mixing vent 44.

The controller 60 would eventually be able to establish a stable and precise gas mixture in a predetermined amount of time. Obviously, the cryogenic liquid blending gas mixture generation system 40 would be designed to reach stable operation prior to maximum supply time capability of the high pressure gas mixture system 20. The ability to create and maintain a stable and precise gas mixture at the required flow and pressure conditions while venting, would also allow the size of the mixing tank 42 to be minimized. All gas would continue to be disposed of through mixing vent 44 during this period.

After stable operation is achieved and maintained, the pressure control valve 46 would begin operation and supply the precise gas mixture to the customer. The mixing vent 44 would vent minimal or no gas during this time. The high pressure gas mixture system 20 could simply be allowed to exhaust its gas supply or automatically or manually shut off. In either event, the cryogenic liquid blending gas mixture generation system would eventually assume the complete supply of the gas mixture.

After the primary gas mixture generation system 15 was operating and supplying product properly, the high pressure gas mixture system 20 would be re-charged and cryogenic liquid blending gas mixture generation system would be idled until required again.

It should be noted that most primary gas mixture generation systems typically have reliability of greater than 99%. This indicates that the gas mixture back-up system will not be operating for long periods of time. The present invention provides for high reliability in spite of these long periods of idle time.

Although illustrated and described herein with reference to specific embodiments, the present invention nevertheless is not intended to be limited to the details shown. Rather, various modifications may be made in the details within the scope and range of equivalents of the claims without departing from the spirit of the invention.

1. A high reliability gas mixture backup system for delivering a precise gas mixture, the system comprising:
a high pressure gas mixture storage system that delivers the precise gas mixture for a short duration of time; and
a cryogenic liquid blending gas mixture generation system that delivers the precise gas mixture for an extended duration of time
wherein the high pressure gas mixture storage system and the cryogenic liquid blending gas mixture generation system deliver an uninterrupted supply of the precise gas mixture.

2. The high reliability gas mixture backup system of claim 1, wherein the high pressure gas mixture storage system comprises at least one high pressure storage vessel.

3. The high reliability gas mixture backup system of claim 1, where the high pressure gas mixture storage system is pressurized to 2:1 to 40:1 of a required delivery pressure.

4. The high reliability gas mixture backup system of claim 1, where the high pressure gas mixture storage system is pressurized by at least one high pressure vaporization vessel using compressed gas directly from a primary gas mixture generation system.

5. The high reliability gas mixture backup system of claim 1, where the high pressure gas mixture storage system is pressurized by at least one cryogenic pump using compressed gas directly from a primary gas mixture generation system.

6. The high reliability gas mixture backup system of claim 1, where the high pressure gas mixture storage system comprises a cryogenic liquid charging system that provides the precise gas mixture at a required high pressure storage vessel pressure.

7. The high reliability gas mixture backup system of claim 1, where the high pressure gas mixture storage system comprises a high pressure product compressor that provides the precise gas mixture at a required high pressure storage vessel pressure.

8. The high reliability gas mixture backup system of claim 1, where the short duration of time wherein the high pressure gas mixture storage system provides the precise gas mixture for up to 20 minutes.

9. The high reliability gas mixture backup system of claim 1, where the cryogenic liquid blending gas mixture generation system uses cryogenic liquids that can be stored at low pressures, above a required delivery pressure.

10. The high reliability gas mixture backup system of claim 1, where the cryogenic liquid blending gas mixture generation system comprises components that require energy which are all pneumatically operated by pressure generated by a common cryogenic liquid vaporization pneumatic back-up system.

11. The high reliability gas mixture backup system of claim 1, where the cryogenic liquid blending gas mixture generation system has monitors that are is in communication with the high pressure gas mixture system to determine if the high pressure gas mixture system is providing a the precise gas mixture.

12. The high reliability gas mixture backup system of claim 11, where the monitors are at least one selected from pressure sensors, flow sensors, and valve position sensors.

13. The high reliability gas mixture backup system of claim 1, further comprising a sensor that is in communication with the high pressure gas mixture system and the cryogenic liquid blending gas mixture generation system that signals the cryogenic liquid blending gas mixture generation system to begin preparing the precise gas mixture.

14. A high reliability gas mixture backup system for delivering a precise gas mixture, the system comprising:
a high pressure gas mixture storage system that delivers the precise gas mixture for up to 20 minutes, is pressurized to 2:1 to 40:1 of a required delivery pressure, and comprises at least one high pressure storage vessel; and
a cryogenic liquid blending gas mixture generation system that delivers the precise gas mixture for an extended duration of time, uses cryogenic liquids that can be stored at low pressures above the required delivery pressure, and comprises at least one monitor that is communication with the high pressure gas mixture system to determine if the high pressure gas mixture system is providing the precise gas mixture.

15. The high reliability gas mixture backup system of claim 14, wherein the high pressure gas mixture storage system is pressurized by at least one high pressure vaporization vessel using compressed gas directly from a primary gas mixture generation system.

16. The high reliability gas mixture backup system of claim 14, wherein the high pressure gas mixture storage system is pressurized by at least one cryogenic pump using compressed gas directly from a primary gas mixture generation system.

17. The high reliability gas mixture backup system of claim 14, wherein the high pressure gas mixture storage system comprises a cryogenic liquid charging system that provides the precise gas mixture at a required high pressure storage vessel pressure.

18. The high reliability gas mixture backup system of claim 14, wherein the high pressure gas mixture storage system comprises a high pressure product compressor that provides the precise gas mixture at a required high pressure storage vessel pressure.

19. A process for providing an uninterrupted supply of a precise gas mixture from a high reliability gas mixture backup system comprising:
providing a high pressure gas mixture storage system;
providing a cryogenic liquid blending gas mixture generation system;
delivering a precise gas mixture from the high pressure storage system for a short duration of time; and
delivering the precise gas mixture from the cryogenic liquid blending gas mixture generation system for an extended duration of time.

20. The process of claim 19, wherein the high pressure storage system comprises at least one high pressure storage vessel.

21. The process of claim 19 wherein the high pressure gas mixture storage system is pressurized to 2:1 to 40:1 of a required delivery pressure.

22. The process of claim 19 wherein the the high pressure gas mixture storage system is pressurized by at least one pressure vaporization vessel using compressed gas directly from a primary gas mixture generation system.

23. The process of claim 19 wherein the high pressure gas mixture storage system is pressurized by cryogenic pumps using compressed gas directly from a primary gas mixture generation system.

24. The process of claim 19 wherein the high pressure gas mixture storage system comprises a cryogenic liquid charging system to provide the precise gas mixture at a required high pressure storage vessel pressure.

25. The process of claim 19 wherein the high pressure gas mixture storage system comprises a high pressure product compressor to provide produce the precise gas mixture at a required high pressure storage vessel pressure.

26. The process of claim 19 wherein the instantaneously delivering step is conducted for up to to 20 minutes.

27. The process of claim 19 wherein the cryogenic liquid blending gas mixture generation system comprises cryogenic liquids that can be stored at low pressures, above a required delivery pressure.

28. The process of claim 19 wherein the cryogenic liquid blending gas mixture generation system comprises components that require energy which are all pneumatically operated by pressure generated by a common cryogenic liquid vaporization pneumatic back-up system.

29. The process of claim 19 wherein the cryogenic liquid blending gas mixture generation system comprises at least one monitor in communication with the high pressure gas mixture system to determine if the high pressure gas mixture system is providing the precise gas mixture.

30. The process of claim 29 wherein the at least one monitor is selected from a pressure sensor, a flow sensor, and a valve position sensor.

31. The process of claim 19 wherein the cryogenic liquid blending gas mixture generation system comprises a sensor that is in communication with the the high pressure gas mixture system that signals the cryogenic liquid blending gas mixture generation system to provide the precise gas mixture.
